(19) United States
(12) Patent Application Publication
(10) Pub. No.: US 2008/0281051 A1
(43) Pub. Date: Nov. 13, 2008

(54) Method for Producing a Plastic Part and Device Comprising Said Plastic Part

(75) Inventors: Snjezana Boger, Esslingen (DE); Peter Englert, Bad Friedrichshall (DE); Hans-Dieter Hinderberger, Stuttgart (DE); Georg Kammler, Stuttgart (DE); Ingo Trautwein, Bietigheim-Bissingen (DE); Thomas Weber- Lanig, Marbach (DE)

Correspondence Address: FOLEY AND LARDNER LLP;SUITE 500, 3000 K STREET NW, WASHINGTON, DC, 20007, US

(73) Assignee: BEHR GMBH & CO. KG, Stuttgart (DE)

(21) Appl. No.: 11/887,432

(22) PCT Filed: Mar. 21, 2006
(86) PCT No.: PCT/EP2006/002598

§ 371 Date: Nov. 28, 2007

(30) Foreign Application Priority Data
Apr. 1, 2005 (DE) 10 2005 015 324.0

(51) Int. Cl. C08L 77/00; B29C 71/02

(52) U.S. Cl. 525/420.5; 264/235; 528/335

(57) ABSTRACT

The invention relates to a method for producing a plastic part. According to said method, a plastic mass is heated to a moulding temperature which is equal to or higher than a melting temperature. Said plastic mass can be moulded by heat from the melting temperature. Plastic mass is moulded when it has reached the moulding temperature, the temperature of the moulding part is adjusted to a conversion temperature which is dependent on the type of plastic and which is lower than the melting temperature, and the moulded part is maintained at a conversion temperature for a defined conversion time frame. The invention also relates to a device comprising a plastic part which is produced according to said inventive method.

The invention relates to a method for producing a plastic part, comprising heating a plastic mass to a molding temperature equal to or above a melting temperature, the plastic mass being thermoformable from the melting temperature up, and also subsequent forming of the plastic mass at molding temperature to give a molding. The invention therefore relates to a device comprising a plastic part produced as claimed in any one of claims 1 to 29.

It is known from the prior art to heat a plastic mass beyond a melting temperature so that it softens to a state of thermoformability. Subsequent forming to give a plastic part takes place frequently by means of an injection molding process or other thermoforming processes. After the plastic mass has been formed to a plastic part said part is usually cooled rapidly to room temperature and left in that state.

It is also known from the prior art to use plastic parts in the field of motor vehicles, where under certain conditions they may take on temperatures of up to 240° C. Moreover, when used in motor vehicles, plastic parts are frequently subject to chemical influences, such as, for instance, water/glycol mixtures with a temperature of more than 100° C. in the engine radiator, hot motor oil in the oil cooler region, gasoline and diesel in the motor fuel region, including hot diesel particularly in the case of diesel heating systems, and other service fluids. Components which are exposed to such aggressive conditions, in particular, are produced from particularly highly stabilized plastics, such as PPS or PA6T/66. These specially optimized plastics carry a high price, accordingly. In certain circumstances the price of these plastics is higher by a multiple than the price of conventional plastics such as polyamides, especially PA6 and PA66. In addition to the increased costs for the material, there are further disadvantages as a result of a possibly more involved processing than in the case of the standard plastics with low-level stabilization. Further disadvantages arise out of specific relationships of dependence of parts manufacturers such as the automobile components supply industry, on plastics manufacturers, as soon as particularly high-grade plastics are used which may only be offered by one manufacturer.

Also known from the prior art, furthermore, are measures such as coating with varnish or surface treatment by plasma or radiation crosslinking on moldings which have been produced beforehand. These measures likewise serve to improve chemical resistance and thermal durability, but are generally involved and therefore costly.

It is the object of the invention to specify a method for producing a plastic part, and also a device comprising a plastic part produced by the method, with which a cost reduction can be achieved as compared with the use of specialty plastics.

This object is achieved for a method of the invention by the features of claim 1.

The setting of the conversion temperature, which is lower than the melting temperature, and the leaving of the molding at the conversion temperature for a defined conversion period, allow the molecular and/or crystalline structure of the plastic to alter after it has been shaped to form a molding, thereby making it possible to achieve improvements—in some cases considerable—in the properties of the plastic part. These improvements relate not only to mechanical properties but also resistance to chemical weathering and to resistance to thermally induced decomposition or degeneration of the molecular structure at high temperatures. Thermoforming in the present case refers to any shape conversion process on plastic material which has softened under the action of heat, including more particularly molding processes such as casting and injection molding techniques.

The setting of the temperature of the molding to conversion temperature is accomplished preferably using air as the thermal conditioning medium, such as in a hot air oven. Other preferred thermal conditioning media are liquid metals, oil baths or, with particular preference, salt baths, which in certain circumstances make it possible to reduce the operating time as compared with air, more particularly by 25%. The molding is preferably immersed into liquid thermal conditioning media. The other operating conditions correspond to those using air as thermal conditioning medium.

In an advantageous embodiment the plastic mass is composed at least partly of an at least partially crystalline thermoplastic, with adjuvants such as fibers being present in particular. As a result of the partial crystallinity, the plastic mass is especially suitable for accomplishment of conversion of molecular structure in accordance with the method of the invention.

In a preferred version of the method of the invention the plastic mass is composed substantially of a polyamide. Experiments have shown that with polyamides in particular the improvement in mechanical properties and chemical resistance and temperature resistance through the method of the invention can be achieved to a particularly large extent. Particular preference is given in this context to a polyamide 66. Alternatively it may be a polyamide 6, a polyamide 46 or a polymer blend in which at least one component, in particular two components, is or are from the group consisting of polyamide 6, polyamide 66, and polyamide 46. A corresponding improvement for the method of the invention ought in principle to be achievable for all of the said polyamides and/or their combinations in a blend or else a copolymer, since polyamides are partially crystalline and have different crystalline phases and also an amorphous phase. By way of explanation, to date only hypothesized, for the improvements achieved through the method of the invention, it could be the case that the temperature treatment of the invention forms a defined, particularly mechanically and chemically stable crystalline phase within the plastic through phase conversion over a defined period.

In an alternative version the plastic mass may also be a polyethylene or else a polypropylene however. It may also be a polyamide 12, of the kind used in hoses, for instance; in this case production in accordance with the invention may result in greater gas tightness or an improved barrier effect with respect to the medium carried, on account of increased crystallinity.

Furthermore, the material in question may be a polyoxymethylene, with which the properties of this substance, which in tribological terms are favorable in any case, are optimized further as a result of a further improvement in crystallinity through the method of the invention. Also conceivable is any other plastic whose mechanical and/or chemical properties and/or high-temperature stability can be improved through a method according to the invention.

In a preferred version of the method of the invention the conversion temperature is not more than about 50° C. below the melting temperature. With particular preference the conversion temperature is not more than 30° C., more preferably not more than about 15° C., and with particular preference not more than about 10° C. below the melting temperature. Here it is found that, depending on the type of plastic, there is in general one particularly suitable conversion temperature, which is generally below but relatively close to the melting temperature. It has been found that not any, arbitrary high temperature leads to a successful treatment of the plastic. Instead, a treatment temperature which is situated too far from the melting temperature may also not bring about any beneficial effect, but instead may merely lead to a degeneration of the shaped plastic part. To the skilled worker, for example, it is general knowledge that in the temperature range from 160° C. onward polyamides rapidly exhibit yellowish discolorations and undergo corresponding degeneration, i.e., become brittle and cracked. Converse effects in the case of a heat treatment just below the melting temperature of a polyamide molding were therefore in no way foreseeable.

In an advantageous embodiment it is possible to cool the plastic mass, prior to step c. of the method, to an intermediate temperature, more particularly room temperature. Depending on the mechanisms of formation of the phases of the plastic and/or its molecular structure, an improvement can be obtained by this measure. With further preference step c. of the method can be performed in such a way that the conversion temperature is attained with a defined rate of temperature change. This takes account of the fact that, in certain cases, phase conversion of the plastic may be favored by the profile of the temperature change and not only by a constant temperature.

It is preferred in general for forming in step b. to take place in a casting process, more particularly in an injection molding process, which allows the method of the invention to be associated with a standard line production process.

It can be advantageous for the setting of the conversion temperature in step c to take place while the plastic mass is located in a mold. This avoids further tools, such as specific ovens, for instance, and allows the operation to run particularly quickly, set against which is the need for increased effort and expenditure as a result of the special design of the injection mold that may be necessary.

In a particularly preferred way the heating to the conversion temperature takes place immediately after the forming of the plastic mass and after operationally inherent cooling, considerable residual heat originating from the forming operation still being present in the plastic mass prior to said heating, and therefore serving to save energy. In an advantageous version the formed plastic mass is transferred to an oven, more particularly a hot air oven, for the purpose of setting the conversion temperature. Overall this allows the production method of the invention to be tied in with existing production operations, and possibly even existing injection molds. In order to counteract unwanted deformation of the plastic parts during thermal conditioning to the near-melting-point conversion temperature, the plastic parts can be introduced into a suitable support mold or mount during thermal conditioning. Instead of a hot air oven it is also possible to select any other conventional way of heating, such as by infrared radiation or, where the material is suitable, by microwave irradiation.

Step c. and/or d. of the method, and/or the thermal conditioning, may advantageously proceed in an inert gas atmosphere such as nitrogen or argon, for instance, so that there is no oxidation at the conversion temperatures, which in some cases are high.

The conversion period advantageously does not amount to less than about one minute. With particular preference the conversion period amounts to not less than about 5 minutes, more preferably not less than about 30 minutes. With particular preference the period does not amount to less than 100 minutes, in particular about 120 minutes. For selected plastics an optimum of material properties has been found within the last-mentioned time range. The conversion period sufficient for achieving the improvement in the properties of the plastic is generally dependent on the type of plastic used. In general, preferably, the conversion period amounts to not more than about three hours. On the one hand this ensures that cost savings tied to the enhancement of relatively low-grade plastics are not eaten up again by energy consumption or other expense. On the other hand, it avoids processes that compete with the enhancement of the plastics at the level of the conversion temperature, such as the irreparable breaking of covalent bonds, gaining the upper hand, which could amount to an impairment of the properties of the resulting plastic part.

In a particularly advantageous version the plastic mass comprises a fraction of a crystallization accelerant, more particularly glass fibers or mineral nanoparticles, which serves, where appropriate, as a nucleating agent. This allows the quality of the resulting plastic part to be optimized further. This optimization is based, in an attempted explanation, on the model wherein, depending on the type of plastic, at the conversion temperature, the crystallization of a favorable crystal phase out of an amorphous phase takes place only slowly or with little promotion. In many cases, in contrast, a transformation from a crystalline phase having unfavorable properties into a crystalline phase having favorable properties may indeed proceed preferentially at conversion temperature. In order in the course of thermoforming to generate, first of all, the unfavorable crystalline phase in as high a fraction as possible relative to the amorphous phase in the plastic part is the purpose of the admixed crystallization accelerant. In steps c. and/or d. of the method, the transformation to a favorable crystalline phase then takes place by thermal conditioning.

The object of the invention is achieved for a device by the features of claim 30, since in the device a plastic part of the invention is used and hence the device can be produced more inexpensively than would be possible in the case of particularly high-value starting materials for the plastic part.

In one preferred version the device is a heat exchanger for a motor vehicle. With particular preference the plastic part in this case is a housing part of a charge air cooler for a motor vehicle. Plastic parts of charge air coolers in particular are subject to very high temperatures of up to about 240° C. in operation. Particularly in the case of these decidedly bulky and hence material-intensive components the use only of very expensive specialty plastics has been state of the art to date.

Alternatively the plastic part can be a housing part of a coolant box of a radiator for a motor vehicle. It may also preferably be a housing part of an oil cooler, part of an interior heating system of a motor vehicle, a component of a thermostat, a component of a motor fuel heating system, a line, more particularly for carrying oil, coolant or air, or else a rotor of a fan. The plastic part may likewise be a line, more particularly a hose, in a cooling circuit of an air conditioning unit, more particularly of a motor vehicle.

All of said components are exemplary of particular requirements imposed on the plastic used with regard to its mechanical stability, chemical stability or thermal stability. In the context of the stated and further components, particularly in the field of a motor vehicle, the art has been of the opinion that conventional plastics with standard stabilization, i.e., plastics without special, high-grade adjuvants, are not suitable, and that instead it is necessary in each case to have recourse to expensive, highly stabilized plastics having particular specialty properties.

Further advantages and features of a method of the invention and of a device of the invention will become apparent from the exemplary embodiments described below and also from the dependent claims.

According to a first preferred exemplary embodiment a plastic mass is composed of the Ultramid® PA66-GF30 product (product code: A3HG6HRsw) of the manufacturer BASF AG. This is a glass fiber reinforced polyamide 66. This standard commercial plastic mass is first heated, after preliminary drying where necessary, to a molding temperature. The melting temperature of this plastic, determined in accordance with ISO 11357-1/-3, is 260° C. The recommended molding temperature to which heating is initially carried out in the present method is approximately 290° C. The recommended temperature of the mold is approximately 85° C.

The polymer, heated to its molding temperature, is initially injected in a manner known per se, under conventional pressures, into the mold, which is preheated at 85° C., the shape of the molding being that of a heat exchanger housing part, more particularly a container part of a charge air cooler of a motor vehicle. As a result of the typically high temperature differences between mold and injected plastic mass, the plastic part thus molded typically cools quickly, at least in its marginal regions, to temperatures of around above 100° C. In particular a temperature range of 240-250° C. is passed through relatively quickly, whereas the region around about 160° C. is passed through much more slowly. In the former temperature range the formation of the a phase of crystallites takes place preferentially for polyamide 66, whereas the formation of γ crystallites takes place preferentially in the latter temperature range of about 160° C. It is therefore to be expected that the solidified and cooled plastic part has a high fraction of γ crystal phase of amorphous, i.e., uncrystallized phase. The fraction of the mechanically and chemically particularly stable a phase in the plastic part is therefore relatively low. These, however, are suppositions, which merely represent an attempt, not yet scientifically confirmed, to explain the favorable effects which arise in the course of the method of the invention. Comparative quantitative large angle X-ray measurements on inventively treated polyamides and also polypropylene, however, have shown these samples to have significantly increased fractions of defined crystalline phases as compared with untreated samples. Moreover, there are indications that, in the case of polyamide 66, the α phase is increased and at the same time the γ crystal phase is reduced, since both breaking stress and tensile strength, simultaneously, are improved in relation to untreated samples.

In the next step of the method, which is still known per se, the shaped plastic part, cooled to around 100° C., is removed from the mold.

For the purpose of improved energy utilization, the plastic part, which is hence still hot, is transferred immediately thereafter into a heating oven in which it is heated to a temperature of 250° C. This temperature is termed the conversion temperature and in the present example is situated 10° C. below the melting point of the plastic mass. At the temperature level of 250° C. the plastic part is left for a period of at least 5 minutes, presently about 120 minutes. Subsequently the plastic part is removed from the hot air oven and without further measures is cooled to room temperature.

The molding aftertreated by thermal conditioning in the hot air oven has considerably improved mechanical properties and resistance to chemical influences and temperature influences as compared with the unaftertreated molding of the prior art which is cooled to room temperature immediately after leaving the mold. For instance, the inventively aftertreated plastic part made from the glass fiber-reinforced polyamide 66 can be used at temperatures well above 200° C. The temperature-induced degeneration of the material is improved by a multiple in relation to that of an unaftertreated plastic part made from the same plastic mass. According to the experiments carried out, the improvement in the temperature stability at long-term service temperatures of about 190° C., but also at temperatures above 200° C., or even up to 240° C. in extreme cases, is so considerable that the inventively aftertreated plastic part made of Ultramid® PA66-GF30 can be used in these segments, as the housing of a charge air cooler, for example, in place of considerably more expensive specialty plastics which are otherwise used there. Specialty plastics of this kind are more particularly PPS or PA6T/66.

It was not foreseeable in accordance with the knowledge in the art today that such favorable properties could be achieved through the inexpensive aftertreatment of the invention. This is so in particular in view of the fact that moldings made from the stated plastic, at temperatures below an appropriate minimum conversion temperature, such as at a temperature of 210° C., for example, are subject to very rapid degeneration. Only the inventive thermal conditioning with a conversion temperature situated just a little below the melting temperature provides the material with corresponding stabilization. This stabilization, in the as yet scientifically unproven explanation attempt referred to already, is attributed to a transformation of amorphous and/or γ crystalline material into the mechanically and chemically more resistant α crystalline phase. Other reasons or alternative reasons for the effects found may also lie in aftercrosslinking of the polymer. Independently of the retrospectively sought explanation for the effects found, their occurrence could not have been foreseen, particularly since conventional polyamide 66 is known to show yellowish discolorations and other phenomena of degeneration of material within a short time even at temperatures above 160° C.

The plastic mass specified shows improvements in material-related properties at conversion temperatures starting from about 30° C. below the melting temperature, in other words from about 230° C. Bringing the conversion temperature nearer to the melting temperature than about 5-10° C. is not advisable, since otherwise the softening which sets in is too severe and hence the molding experiences an inadmissibly large change in shape.

In the present example the treated plastic part was subjected to a loading test and was compared with an untreated part otherwise produced by injection molding in the same way. The loading consisted of storing the plastic parts in a water/glycol mixture (50:50, standard engine coolant) at a temperature of 130° C.—of a kind which hardly ever occurs in practice—for 1000 hours. After this treatment, the breaking strength of the untreated plastic part had dropped to 18% of the initial level, and that of the inventively treated part to 34%. With regard to the breaking elongation, the figure for the untreated part had dropped to 31%, and that of the inventively treated part to 55%. This suggests approximately a two-fold increase in the resistance to water/glycol mixture at 130° C. In practice this may be critical in determining whether a plastic part can be used, say, for a radiator housing or not.

In a second preferred exemplary embodiment the plastic mass is composed of the Celstran® PA66 GF50-02 P11-14 starting material produced by the company Ticona. This polyamide 66 also has a melting point or softening point of about 260° C. Here again, thermal conditioning for a period of at least several minutes at a temperature of about 10° below the melting temperature leads to considerable improvements in the material-related property of the plastic part shaped beforehand. As in the first exemplary embodiment, the plastic part is shaped under standard conditions in accordance with the manufacturer's recommended operating data for injection molding.

The inventive improvements through thermal conditioning at just below the melting point were also found in experiments for plastics of the type PA6, whose melting point is typically about 220° C. The preferred conversion temperature in this case would be about 210° C.

In a third preferred exemplary embodiment the plastic mass was composed of a glass fiber-free polyamide 66, namely Ultramid® from BASF bearing the product designation “A3Ksw”. Here again, thermal conditioning at 10° C. below the melting point for a period of 30 minutes and for a period of 120 minutes led to an improvement in the material-related properties, with a marked change in the crystal structure, moreover, being confirmed by structural analysis measurements.

In a fourth preferred exemplary embodiment the plastic mass was composed of a glass fiber-free polyamide 6. Here again, thermal conditioning at 10° C. below the melting point for a period of 30 minutes and for a period of 120 minutes led to an improvement in the material-related properties, with a marked change in the crystal structure, moreover, being confirmed by structural analysis measurements.

In a fifth preferred exemplary embodiment, the plastic mass was composed of a polypropylene, namely “Stamylan P4935” from the manufacturer Sabic. In the case of the polypropylene as well, a thermal conditioning at 10° C. below the melting point for a period of 30 minutes and also for a period of 120 minutes led to an improvement in the material-related properties. Here again, a change in the crystal structure was confirmed by structural analysis measurements against an unconditioned comparison sample.

The favorable effects arising from the production method of the invention also apply to plastics of polypropylene (PP), polyethylene (PE), polyethylene terephthalate (PET), polybutylene terephthalate (PBT), polyamide 46 (manufacturer: DSM, Netherlands), and generally for a multitude of at least partially crystalline thermoplastics which in particular include aromatic and/or halogenated constituents, fluorine or chlorine for example. For this class of materials, therefore, a normally stabilized polymer can be provided through a production method of the invention with properties of a kind which otherwise occur only in highly stabilized polymers of the same class. Expressed in simplified terms, therefore, the method of the invention, through changes in the molecular and/or crystalline structure of the simple and inexpensive plastic, produces material-related properties of a kind which can otherwise be achieved, under conventional plastic part production processes, only by means of highly stabilized plastics, in other words plastics having a particularly costly and inconvenient formula of adjuvants.

1. A method for producing a plastic part, comprising:
a. heating a plastic mass to a molding temperature equal to or above a melting temperature, the plastic mass being thermoformable from the melting temperature up;
b. forming the plastic mass which is at molding temperature, to give a molding;
c. setting the temperature of the molding to a conversion temperature, which is dependent on the type of plastic and is lower than the melting temperature,
d. leaving the molding at the conversion temperature for a defined conversion period.

2. The method of claim 1, wherein the plastic mass comprises at least partly an at least partially crystalline thermoplastic, with adjuvants such as fibers being present in particular.

3. The method of claim 1, wherein the plastic mass is comprised substantially of a polyamide.

4. The method of claim 3, wherein the plastic mass comprises substantially a polyamide 66.

5. The method of claim 3, wherein the plastic mass comprises substantially a polyamide 6.

6. The method of claim 3, wherein the plastic mass comprises substantially a polyamide 46.

7. The method of claim 3, wherein the plastic mass comprises substantially a polyamide 12.

8. The method of claim 3, wherein the plastic mass is a polymer blend in which at least one component, more particularly two components, is or are from the group consisting of polyamide 6, polyamide 66, and polyamide 46.

9. The method of claim 1, wherein the plastic mass at least partly comprises polyethylene.

10. The method of claim 1, wherein the plastic mass at least partly comprises polypropylene.

11. The method of claim 1, wherein the plastic mass at least partly comprises polyoxy-methylene (POM).

12. The method of claim 1, wherein the conversion temperature is not more than about 50° below the melting temperature.

13. The method of claim 1, wherein the conversion temperature is not more than about 30° below the melting temperature.

14. The method of claim 1, wherein the conversion temperature is not more than about 15° below the melting temperature.

15. The method of claim 1, wherein the conversion temperature is not more than about 10° below the melting temperature.

16. The method of claim 1, wherein, before step c., the plastic mass is cooled to an intermediate temperature, more particularly room temperature.

17. The method of claim 16, wherein the cooling takes place at a predetermined cooling rate.

18. The method of claim 1, wherein the plastic mass in step c. is brought to the conversion temperature with a predetermined rate of temperature change.

19. The method of claim 1, wherein the forming in step b. takes place in a casting process, in particular in an injection molding process.

20. The method of claim 19, wherein the setting of the conversion temperature in step c. takes place while the plastic mass is located in a mold.

21. The method of claim 1, wherein heating to the conversion temperature takes place immediately after the forming of the plastic mass and such that, after operationally inherent cooling, considerable residual heat originating from the forming operation is still present in the plastic mass prior to said heating.

22. The method of claim 21, further comprising transferring the formed plastic mass to an oven, more particularly a hot air oven, for the purpose of setting the conversion temperature.

23. The method of claim 1, wherein at least during step c. and/or d. of the method the plastic part is located in an inert gas atmosphere.

24. The method of claim 1, wherein the conversion period amounts to not less than about 1 minute.

25. The method of claim 1, wherein the conversion period amounts to not less than about 5 minutes.

26. The method of any claim 1, wherein the conversion period amounts to not less than about 30 minutes.

27. The method of claim 1, wherein the conversion period amounts to not less than about 100 minutes.

28. The method of claim 1, wherein the conversion period amounts to not more than about three hours.

29. The method of claim 1, wherein the plastic mass comprises a fraction of a crystallization accelerant, more particularly glass fibers or mineral particles, preferably nanoparticles.

30. A device comprising a plastic part produced as claimed in claim 1.

31. The device of claim 30, wherein the device is a component of a heat exchanger for a motor vehicle.

32. The device of claim 31, wherein the plastic part is a housing part of a charge air cooler for a motor vehicle.

33. The device of claim 31, wherein the plastic part is a housing part of a coolant box of a radiator for a motor vehicle.

34. The device of claim 31, wherein the plastic part is a housing part of an oil cooler.

35. The device of claim 31, wherein the plastic part is a component of a heater of an interior heating system of a motor vehicle.

36. The device of claim 30, wherein the plastic part is a component of a thermostat.

37. The device of claim 30, wherein the plastic part is a component of a motor fuel heating system.

38. The device of claim 30, wherein the device is a line, more particularly for carrying oil, coolant or air.

39. The device of claim 30, wherein the plastic part is a rotor of a fan.

40. The device of claim 30, wherein the plastic part is a line in a cooling circuit of an air conditioner.
